(19) United States
(12) Patent Application Publication
(10) Pub. No.: US 2003/0086038 A1
(43) Pub. Date: May 8, 2003

(54) Liquid crystal device and electronic equipment

(75) Inventor: Osamu Okumura, Chino-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/279,056

(22) Filed: Oct. 24, 2002

(30) Foreign Application Priority Data
Oct. 24, 2001 (JP) 2001-326521

(51) Int. Cl. G02F 1/1335

(52) U.S. Cl. 349/115

(57) ABSTRACT

The invention provides a transflective liquid crystal device with superior visibility that is capable of enhancing the brightness of display in a transmissive mode while maintaining the brightness of display in a reflective mode. A transflective liquid crystal device in accordance with the present invention is equipped with a cholesteric reflective layer that is provided on the inner surface side of a color filter substrate (lower substrate) and reflects at least a part of circular polarized light having a predetermined direction of rotation, and an upper substrate elliptic polarized light introducing device to cause elliptic polarized light to enter a liquid crystal layer through an opposing substrate (upper substrate). The twist angle of the liquid crystal layer ranges from 0 to 12° and a Δn·d value is 0.37±0.05 μm, or the twist angle of the liquid crystal layer is 130±20° and the Δn·d value is 0.76±0.05 mm. The liquid crystal layer is configured such that it inverts the direction of rotation of incident elliptic polarized light in a non-selection voltage application mode, while it does not change the direction of rotation of the incident elliptic polarized light in a selection voltage application mode.

### BACKGROUND OF THE INVENTION

1. Field of Invention

The present invention relates to a liquid crystal device and electronic equipment. More specifically, the invention relates to a construction of a transflective liquid crystal device featuring superior display quality that is capable of providing sufficiently bright display, not only in a reflective display mode but also in a transmissive display mode.

2. Description of Related Art

Reflective liquid crystal devices have been used in the related art with a variety of portable electronic equipments because of their low power consumption since they do not have light sources, such as backlights. However, the reflective liquid crystal devices utilize external light, such as natural light or illumination light, to perform display, presenting a problem in that it is difficult to view the display in a dark place. To solve the problem, there has been proposed a liquid crystal device that uses external light, as in the case of a standard reflective liquid crystal device in a bright place, while it enables the display to be viewed by a light source incorporated therein in a dark place. More specifically, the liquid crystal device adopts a display method that combines a reflective type and a transmissive type, and switches its display method to the reflective mode or the transmissive mode according to the brightness of its surroundings so as to reduce power consumption and permit clear display even in a dark place. Hereinafter, this type of liquid crystal device will be referred to as a “transflective liquid crystal device.”

An exemplary related art transflective liquid crystal device is a liquid crystal device in which the inner surface of a lower substrate (the surface of the substrate on the liquid crystal side being referred to as “the inner surface”, and the surface opposite from that being referred to as “the outer surface”) is provided with a reflective layer having an opening to transmit light formed in a metal film made of aluminum or the like. The reflective layer is adapted to function as a transflective layer.

An exemplary related art passive matrix type transflective liquid crystal device using this type of transflective layer is shown in FIG. 14.

A transflective liquid crystal device 100 shown in FIG. 14 is formed primarily of a liquid crystal cell in which a liquid crystal layer 103 is sandwiched between a pair of substrates 101 and 102. On the inner surface of the lower substrate 101, a transflective layer 104, an insulating film 106, a transparent electrode 108, and an alignment layer 107 are deposited in sequence. On the inner surface of the upper substrate 102, a transparent electrode 112 and an alignment film 113 are deposited in sequence. The transflective layer 104 is formed of a reflective layer having an opening 110 for each dot, and it is a film in which the opening 110 functions as a light transmitting portion, while the remaining portion functions as a light reflecting portion.

Furthermore, a ¼-wavelength plate 115, which is a retardation film, and a lower polarizer 116 are adhesively attached in order to the outer surface of the lower substrate 101. An upper retardation film 119 and an upper polarizer 114 are adhesively attached in order to the outer surface of the upper substrate 102. A backlight (not shown) is disposed below the lower polarizer 116.

The transflective liquid crystal device 100 is roughly constructed as described above. Upon usage of the transflective liquid crystal device 100 having such a construction in the reflective mode, external light, including sunlight and illuminating light, is incident upon the liquid crystal cell through the upper substrate 102, transmitted through the liquid crystal layer 103, reflected off the surface of the transflective layer 104 on the lower substrate 101, then transmitted through the liquid crystal layer 103 again to exit to the upper substrate 102 so as to perform display. In contrast to this, in the transmissive mode, the light emitted from the backlight is transmitted through the opening 110 of the transflective layer 104, transmitted through the liquid crystal layer 103, and emitted to the upper substrate 102 so as to perform display.

### SUMMARY OF THE INVENTION

However, the related art transflective liquid crystal device shown in FIG. 14 is subject to a problem in that, although the display can be viewed regardless of the presence of external light, the brightness of the display in the transmissive mode is far inferior, as compared with the display in the reflective mode. This problem is mainly caused by (a) only about half the light incident upon the liquid crystal layer is used for display, (b) the ¼-wavelength plate and the lower polarizer are provided on the outer surface of the lower substrate, and (c) only the light that has been transmitted through the openings of the transflective layer is used when the display is effected in the transmissive mode.

This will be explained with reference to FIG. 14. However, in the following explanation, a construction in which dark display is carried out when a non-selection voltage is applied, while bright display is carried out when a selection voltage is applied.

In the transflective liquid crystal device 100 shown in FIG. 14, when the dark display of the reflective mode is performed under the application of the non-selection voltage, if the transmission axis of the upper polarizer 114 is parallel to the paper surface, then only the linear polarized light having a polarization axis parallel to the paper surface, of the external light incident upon the upper substrate 102 is transmitted through the upper polarizer 114. The linear polarized light is converted into a circular polarized light by the birefringence effect of the liquid crystal layer 103 in the course of the transmission through the upper retardation film 119 and the liquid crystal layer 103.

When the circular polarized light is reflected off the surface of the transflective layer 104 on the lower substrate 101, it turns into circular polarized light with an inverted direction of rotation. When the circular polarized light is transmitted through the liquid crystal layer 103 and the upper retardation film 119 again, it turns into linear polarized light having a polarization axis perpendicular to the paper surface, and reaches the upper polarizer 114. In this case, the upper polarizer 114 is a polarizer having a transmission axis parallel to the paper surface, so that the light reflected off the transflective layer 104 is absorbed by the upper polarizer 114 and is not emitted toward an observer. This results in a dark display.

Conversely, when the bright display in the reflective mode is carried out under the application of the selection voltage, the liquid crystal molecules in the liquid crystal layer 103 mostly change their orientation along a produced longitudinal electric field. Designing the residual phase difference so as to be balanced with the phase difference of the upper retardation film 119 causes the linear polarized light that has been transmitted through the upper polarizer 114 to transmit the liquid crystal layer 103 as is. The linear polarized light is then reflected off the transflective layer 104, transmitted through the upper polarizer 114, and emitted toward the observer. This results in a bright display.

Meanwhile, to carry out display in the transmissive mode, the light emitted from the backlight enters the liquid crystal cell through the lower substrate 101. Of the incident light, only the light that has been transmitted through the openings 110 of the transflective layer 104 provides the light contributing to the display.

In this case, to affect the dark display under the application of the non-selection voltage, the light directed toward the liquid crystal layer 103 through the openings 110 of the transflective layer 104 must be the circular polarized light, as in the case of the dark display in the reflective mode.

Therefore, when the bright display is carried out under the application of the selection voltage, the circular polarized light enters the liquid crystal layer 103, causing the circular polarized light to be emitted through the liquid crystal layer 103 and the upper retardation film 119. However, half the circular polarized light is absorbed by the upper polarizer 114. As a result, therefore, only about half the light incident upon the liquid crystal layer 103 contributes to the display. Thus, the related art transflective liquid crystal device 100 had to use the different display modes for the reflective display and the transmissive display, causing its display mechanism to inevitably provide the dark display in the transmissive mode.

Furthermore, in order to turn the light directed toward the upper substrate 102 through the opening 110 of the transflective layer 104 into the circular polarized light, the light that is emitted from the backlight and transmitted through the opening 110 of the transflective layer 104 must be circular polarized light. This requires the ¼-wavelength plate 115 to convert the linear polarized light, which has transmitted through the lower polarizer 116, into the circular polarized light. The ¼-wavelength plate is a retardation film capable of converting linear polarized light into circular polarized light at a certain wavelength.

Attention is now focused on the light that does not transmit through the openings 110 of the transflective layer 104 in the light emitted from the backlight. If the transmission axis of the lower polarizer 116 is perpendicular to the paper surface, only the linear polarized light perpendicular to the paper surface out of the light emitted from the backlight is transmitted through the lower polarizer 116, converted into circular polarized light by the ¼-wavelength plate 115, and reaches the transflective layer 104. Furthermore, when the circular polarized light is reflected off the bottom surface of the transflective layer 104, it turns into circular polarized light with an inverted direction of rotation, and this circular polarized light is converted into linear polarized light having a polarization axis parallel to the paper surface when transmitting through the ¼-wavelength plate 115 again. The linear polarized light is absorbed by the lower polarizer 116 having the transmission axis perpendicular to the paper surface. In other words, of the light emitted from the backlight, the light that is not transmitted through the opening 110 of the transflective layer 104 is reflected off the bottom surface of the transflective layer 104, then substantially all of the reflected light is absorbed by the lower polarizer 116.

Thus, in the transflective liquid crystal device 100, to carry out display in the transmissive mode, in addition to the fact that only about half the light entering the liquid crystal layer 103 contributes to the display, substantially all the light reflected off the transflective layer 104 is absorbed by the lower polarizer 116 without being transmitted through the opening 110 of the transflective layer 104. This causes the dark display in the transmissive mode.

Increasing the aperture ratio of the transflective layer 104 increases the brightness of the display in the transmissive mode. Increasing the aperture ratio, however, decreases the area of the light reflecting portion of the transflective layer 104, resulting in darker display in the reflective mode. Hence, to secure the brightness in the reflective mode, the aperture ratio of the transflective layer 104 cannot be increased beyond a certain extent, thus limiting the enhancement in the brightness in the transmissive mode.

Accordingly, the present invention addresses or solves the above problem, and provides a transflective liquid crystal device that permits enhanced brightness of the display in a transmissive mode while maintaining the brightness of the display in the reflective mode and features high visibility, and electronic equipment provided with the liquid crystal device.

The inventors have found that the brightness of the display in the transmissive mode can be enhanced by constructing a transflective liquid crystal device by using a cholesteric reflective layer that has recently been proposed in a reflective liquid crystal device, and making elliptic polarized light incident upon a liquid crystal layer to perform display.

The “cholesteric reflective layer” means a layer constituted by at least one cholesteric liquid crystal layer. The cholesteric liquid crystal layer is characteristic in that it selectively reflects circular polarized light whose wavelength is equal to the value obtained by multiplying the spiral pitch of the liquid crystal molecules making up the cholesteric liquid crystal layer by the refractive index thereof and whose direction of rotation is the same as the spiral winding direction, while it transmits light whose wavelength is not equal to the value obtained by multiplying the spiral pitch of the liquid crystal molecules making up the cholesteric liquid crystal layer by the refractive index thereof and circular polarized light that has a wavelength equal to the value obtained by multiplying the spiral pitch of the liquid crystal molecules making up the cholesteric liquid crystal layer by the refractive index thereof but has a direction of rotation opposite from the spiral winding direction. Accordingly, for example, at least three different cholesteric liquid crystal layers that individually selectively reflect red, green, and blue circular polarized lights having the same direction of rotation may be stacked so as to provide a cholesteric reflective layer that selectively reflects circular polarized lights in virtually entire range (white) of visible lights having a particular direction of rotation.

To effect display by making elliptic polarized light incident upon the liquid crystal layer as described above, a liquid crystal mode different from a TN (Twisted Nematic) mode, an STN (Super Twisted Nematic) mode, or the like in which linear polarized light is incident upon the liquid crystal layer will be necessary to enhance or optimize the display characteristics, such as brightness and contrast in both the reflective mode and the transmissive mode. The inventors have carried out diverse studies and found a liquid crystal mode that exhibits optimum display characteristics in both reflective mode and transmissive mode. The liquid crystal mode has also been found to be applicable to a reflective liquid crystal device that uses a cholesteric reflective layer and makes elliptic polarized light incident upon the liquid crystal layer to effect display.

The inventors have focused attention on the above aspects and invented the following liquid crystal device. The liquid crystal device in accordance with the present invention is especially ideal as a transflective liquid crystal device. However, the invention is also applicable to a reflective liquid crystal device.

A first liquid crystal device in accordance with the present invention is a liquid crystal device having a liquid crystal cell in which a liquid crystal layer is sandwiched between an upper substrate and a lower substrate disposed so as to oppose each other, including a voltage applying device to apply a voltage to the liquid crystal layer, a cholesteric reflective layer that is provided on the inner surface side of the lower substrate and reflects at least a part of circular polarized light having a predetermined direction of rotation, and an upper substrate elliptic polarized light introducing device to cause elliptic polarized light to be incident upon the liquid crystal layer from the upper substrate side. The liquid crystal layer has a twist angle ranging from 0 to 12° and a Δn·d value of 0.37±0.05 mm, and the liquid crystal layer inverts the direction of rotation of the incident elliptic polarized light in a non-selection voltage application mode, while it does not change the direction of rotation of the incident elliptic polarized light in a selection voltage application mode.

A second liquid crystal device in accordance with the present invention is a liquid crystal device having a liquid crystal cell in which a liquid crystal layer is sandwiched between an upper substrate and a lower substrate disposed so as to oppose each other, including a voltage applying device to apply a voltage to the liquid crystal layer, a cholesteric reflective layer that is provided on the inner surface side of the lower substrate and reflects at least a part of circular polarized light having a predetermined direction of rotation, and an upper substrate elliptic polarized light introducing device to cause elliptic polarized light to be incident upon the liquid crystal layer from the upper substrate side. The liquid crystal layer has a twist angle of 130±20° and a Δn·d value of 0.76±0.05 mm, and the liquid crystal layer inverts the direction of rotation of the incident elliptic polarized light in a non-selection voltage application mode, while it does not change the direction of rotation of the incident elliptic polarized light in a selection voltage application.

In this specification, the “Δn·d value” means the product of the An value that indicates the difference between an abnormal light refraction index “ne” and a normal light refraction index “no” of liquid crystal and a cell thickness “d” value of the liquid crystal layer. Furthermore, “the non-selection voltage application mode” and “the selection voltage application mode” means “a mode in which the voltage applied to the liquid crystal layer is in the vicinity of the threshold voltage of a liquid crystal” and “a mode in which the voltage applied to the liquid crystal layer is sufficiently higher than the threshold voltage of the liquid crystal”.

Thus, the first and second liquid crystal devices in accordance with the present invention adopt the construction in which the cholesteric reflective layer is provided on the inner surface of the lower substrate, and elliptic polarized light is entered in the liquid crystal layer to effect display. The liquid crystal layer is constructed such that it inverts the direction of rotation of the incident elliptic polarized light in the non-selection voltage application mode, while it does not change the direction of rotation of the incident elliptic polarized light in the selection voltage application mode. This construction is utilized to effect the display.

The inventors have found that the use of such a construction and the application of the first and second liquid crystal devices in accordance with the present invention to a transflective liquid crystal device allow the same display mode to be used for both reflective display and transmissive display, enabling the display mechanism to address or solve the problem of dark display in the transmissive mode. It has also been discovered that the selective reflection by the cholesteric reflective layer makes it possible to reuse the light reflected off the lower substrate in the same conventional construction of the outer surface side of the lower substrate, so that the brightness of the display in the transmissive mode can be enhanced. As a result, it has been discovered that a transflective liquid crystal device can be achieved that permits enhanced brightness of display in the transmissive mode while maintaining the brightness of display in the reflective mode at the same time and exhibits high visibility. The display mechanisms of the first and second liquid crystal devices in accordance with the present invention, and the reasons why such advantages can be obtained will be described in detail in the Detailed Description section of this application.

If it is assumed that the major axis of liquid crystal molecules is perfectly horizontal to a substrate surface in the non-selection voltage application mode, then the direction of rotation of the elliptic polarized light incident upon the liquid crystal layer can be inverted when it exits from the liquid crystal layer, when the Δn·d value of the liquid crystal layer takes an odd multiple of λ/2 (where λ denotes the wavelength of the light incident upon the liquid crystal layer). In contrast to this, in the selection voltage application mode, the liquid crystal molecules in the liquid crystal layer mostly change their orientation along a produced longitudinal electric field. This reduces the phase difference in the liquid crystal layer, and the direction of rotation of the elliptic polarized light that has entered the liquid crystal layer remains unchanged even after transmitting through the liquid crystal layer. Accordingly, making use of these characteristics permits the liquid crystal layer to be constructed so that it inverts the direction of rotation of the incident elliptic polarized light in the non-selection voltage application mode, while it does not change the direction of rotation of the incident elliptic polarized light in the selection voltage application mode.

To be more specific, when light (green light) having a wavelength of 550 nm is taken as an example, λ/2 is 0.275 μm. Theoretically, therefore, setting the Δn·d value to an odd multiple of 0.275 μm makes it possible to invert the direction of rotation of the elliptic polarized light having the wavelength of 550 nm, which has entered the liquid crystal layer in the non-selection voltage application mode, when the elliptic polarized light is emitted from the liquid crystal layer. Actually, however, the liquid crystal molecules have tilt angles in the non-selection voltage application mode, and not only one wavelength but almost all visible lights are incident upon the liquid crystal layer. Mainly for these reasons, the direction of rotation of the elliptic polarized light incident upon the liquid crystal layer in the non-selection voltage application mode can be inverted when the elliptic polarized light exits from the liquid crystal layer by setting the Δn·d value to a value slightly deviating from an odd multiple of 0.275 μm.

The inventors have studied the optimization of display characteristics by satisfying the requirement that: the liquid crystal layer inverts the direction of rotation of the incident elliptic polarized light in the non-selection voltage application mode, and does not change the direction of rotation of the incident elliptic polarized light in the selection voltage application mode. It has been found that optimum display characteristics, including brightness and contrast, can be obtained when the twist angle ranges from 0 to 12° and the Δn·d value is 0.37±0.05 μm, which is significantly larger than λ/2, or when the twist angle is 130±20° and the ≢n·d value is 0.76±0.05 μm, which is almost three times the value of λ/2, when the twist angle is low, namely, below 150°. The foundation on which the display characteristics can be enhanced or optimized by setting the above conditions will be explained in the Detailed Description section of this application.

Thus, in the first and second liquid crystal devices according to the present invention, since the liquid crystal mode (the twist angle and the Δn·d value) is optimized, the display characteristics, including brightness and contrast, can be enhanced or optimized in both reflective mode and transmissive mode according to the first and second liquid crystal devices of the present invention, enabling transflective liquid crystal devices having superior display quality to be provided. Moreover, the liquid crystal mode can be applied also to a reflective liquid crystal device, and the display characteristics, such as brightness and contrast, can be enhanced or optimized according to the first and second liquid crystal devices of the present invention, enabling a reflective liquid crystal device having superior display quality to be provided.

The inventors have also found that, in the first and second liquid crystal devices according to the present invention, the display characteristics, such as brightness and contrast, can be further enhanced or optimized by making an arrangement such that the upper substrate elliptic polarized light introducing device causes elliptic polarized light having a different direction of rotation from that of the circular polarized light reflected by the cholesteric reflective layer to enter the liquid crystal layer. In addition, this condition has been found to be particularly suitable when the present invention is applied to a transflective liquid crystal device. This is not preferred in any other constructions, such as one in which elliptic polarized light having the same direction of rotation as that of the circular polarized light reflected by the cholesteric reflective layer is received, because there is a possible problem, such as one in which an unwanted color is mixed in display.

A third liquid crystal device in accordance with the present invention is a liquid crystal device having a liquid crystal cell in which a liquid crystal layer is sandwiched between an upper substrate and a lower substrate disposed so as to oppose each other, including a voltage applying device to apply a voltage to the liquid crystal layer, a cholesteric reflective layer that is provided on the inner surface side of the lower substrate and reflects at least a part of circular polarized light having a predetermined direction of rotation, and an upper substrate elliptic polarized light introducing device to cause elliptic polarized light to be incident upon the liquid crystal layer from the upper substrate side. The liquid crystal layer has a twist angle ranging from 150° to 270° and a Δn·d value is represented by the following expression (1) when the twist angle is denoted by θ (°), and the liquid crystal layer inverts the direction of rotation of the incident elliptic polarized light in one of a non-selection voltage application mode and a selection voltage application mode, while it does not change the direction of rotation of the incident elliptic polarized light in the other mode:

Δn·d value (μm)=−6.7×10⁻⁶×θ²+4.3×10⁻³×θ+0.39±0.1 (1)

Thus, as in the case of the first and second liquid crystal devices of the present invention, the third liquid crystal device according to the present invention adopts the construction in which the cholesteric reflective layer is provided on the inner surface of the lower substrate, and elliptic polarized light is entered in the liquid crystal layer to effect display. The liquid crystal layer is constructed such that it inverts the direction of rotation of the incident elliptic polarized light in one of the non-selection voltage application mode and the selection voltage application mode, while it does not change the direction of rotation of the incident elliptic polarized light in the other mode. This construction is utilized to effect the display.

As in the case of the first and second liquid crystal devices according to the present invention, because of the use of such a construction, its application to a transflective liquid crystal device allows the same display mode to be used for both reflective display and transmissive display, enabling the display mechanism to address or solve the problem of dark display in the transmissive mode. Furthermore, the selective reflection by the cholesteric reflective layer makes it possible to reuse the light reflected off the lower substrate in the same related art construction of the outer surface side of the lower substrate, so that the brightness of the display in the transmissive mode can be enhanced. As a result, a transflective liquid crystal device can be achieved that permits improved brightness of display in the transmissive mode while maintaining the brightness of display in the reflective mode at the same time and exhibits high visibility. The display mechanisms of the third liquid crystal device in accordance with the present invention will be described in detail in the Detailed Description section of this application

The inventors have studied the optimization of display characteristics while meeting the requirement: the liquid crystal layer inverts the direction of rotation of the incident elliptic polarized light in one of the non-selection voltage application mode and the selection voltage application mode, and does not change the direction of rotation of the incident elliptic polarized light in the other mode. It has been found that optimum display characteristics, including brightness and contrast, can be obtained when the Δn·d value is represented by the above expression (1) when the twist angle is denoted by θ at a high twist angle ranging from 150° to 270°. The foundation on which the display characteristics can be optimized by setting the above conditions will be explained in Detailed Description section of this application.

Thus, also in the third liquid crystal devices according to the present invention, since the liquid crystal mode (the twist angle and the Δn·d value) is enhanced or optimized, the display characteristics, including brightness and contrast, can be enhanced or optimized in both reflective mode and transmissive mode according to the third liquid crystal device of the present invention, enabling a transflective liquid crystal device having superior display quality to be provided. Moreover, the liquid crystal mode can be applied also to a reflective liquid crystal device, and the third liquid crystal device in accordance with the present invention allows display characteristics, such as brightness and contrast, to be enhanced or optimized. Thus, it is possible to provide a reflective liquid crystal device having superior display quality.

Under the high twist condition, as in the case of the foregoing first and second liquid crystal devices in accordance with the present invention, an arrangement can be made such that the liquid crystal layer inverts the direction of rotation of incident elliptic polarized light in the non-selection voltage application mode, while it does not change the direction of rotation of incident elliptic polarized light in the selection voltage application mode. This arrangement may be reversed.

For instance, in the non-selection voltage application mode, setting the Δn·d value to a value close to an even multiple of λ/2 causes the elliptic polarized light entering the liquid crystal layer to reverse the direction of rotation by an even number of times so as to set it to the original direction of rotation. This makes it possible to not change the direction of rotation of the incident elliptic polarized light in the non-selection voltage application mode.

However, the inventors have also found that the display characteristics, such as brightness and contrast, can be further enhanced or optimized by making an arrangement such that the upper substrate elliptic polarized light introducing device causes elliptic polarized light having the same direction of rotation as that of the circular polarized light reflected by the cholesteric reflective layer to enter the liquid crystal layer. It has been further found that the condition is especially suited when the present invention is applied to a transflective liquid crystal device.

To apply the first to the third liquid crystal devices to a transflective liquid crystal device, an arrangement may be made such that the cholesteric reflective layer functions as a transflective layer that reflects a part of and transmits a part of the elliptic polarized light having a predetermined direction of rotation, and an illuminating device to cause light to be incident upon the liquid crystal cell from the lower substrate side and a lower substrate elliptic polarized incident device to cause elliptic polarized light to be incident upon the liquid crystal layer from the lower substrate side are further added. With this arrangement, elliptic polarized light can be incident upon the liquid crystal layer from the lower substrate, allowing the same display mode to be applied to both transmissive display and reflective display.

Specific forms of the upper substrate elliptic polarized light introducing device and the lower substrate elliptic polarized light introducing device may be illustrated by a polarizer that transmits linear polarized light having a polarization axis in a particular direction and a retardation film to convert the linear polarized light that has been transmitted through the polarizer into elliptic polarized light. By using these two optical elements, external light, such as sunlight or illumination light, and the illumination light from a built-in illuminating device, can be easily converted into elliptic polarized light.

The provision of the first to the third liquid crystal devices in accordance with the present invention makes it possible to provide electronic equipment in accordance with the present invention that exhibits superior display characteristics, including brightness and contrast.

### BRIEF DESCRIPTION OF THE DRAWINGS

FIG. 1 is a schematic perspective view showing the entire construction of a transflective liquid crystal device of an embodiment in accordance with the present invention;

FIG. 2 is a partial schematic sectional view of the transflective liquid crystal device of an embodiment in accordance with the present invention;

FIG. 3 is a schematic explaining display modes of the transflective liquid crystal device of the embodiment in accordance with the present invention;

FIG. 4 is a schematic explaining display modes of the transflective liquid crystal device of the embodiment in accordance with the present invention;

FIG. 5 is a schematic explaining display modes of the transflective liquid crystal device of the embodiment in accordance with the present invention;

FIG. 6 is a schematic explaining display modes of the transflective liquid crystal device of the embodiment in accordance with the present invention;

FIG. 7(a) is a perspective view showing an example of a cellular telephone equipped with the transflective liquid crystal device of the above embodiment; FIG. 7(b) is a perspective view showing an example of a portable information processing apparatus equipped with the transflective liquid crystal device of the above embodiment; and FIG. 7(c) is a perspective view showing an example of wristwatch type electronic equipment provided with the transflective liquid crystal device of the above embodiment;

FIG. 8 is a chart showing the relationship between ΔE (550 nm) value on the light having a wavelength of 550 nm and the twist angle θ and the Δn·d value of the liquid crystal layer in Example 1;

FIG. 9 is a chart showing the relationship between an average ΔEm value of the ΔE value on each color light and the twist angle θ and the Δn·d value of the liquid crystal layer in Example 1;

FIG. 10 is a chart showing the relationship between the ΔE (550 nm) value on the light having a wavelength of 550 nm and the twist angle θ and the Δn·d value of the liquid crystal layer in Example 2;

FIG. 11 is a chart showing the relationship between the average ΔEm value of the ΔE value on each color light and the twist angle θ and the Δn·d value of the liquid crystal layer in Example 2;

FIGS. 12(a) and (b) are graphs that show an example of the relationship between applied voltage (V) and light transmissivity (T) in a transmissive display mode and an example of the spectral characteristics of the light emergent from a liquid crystal cell in the transmissive display mode, respectively, of the liquid crystal device obtained in Example 3;

FIGS. 13(a) and (b) are charts that show an example of the relationship between applied voltage (V) and light transmissivity (T) in a transmissive display mode, and an example of the spectral characteristics of the light emergent from a liquid crystal cell in the transmissive display mode, respectively, of the liquid crystal device obtained in Example 4;

FIG. 14 is a schematic sectional view showing a structure of a related art transflective liquid crystal device.

### DETAILED DESCRIPTION OF PREFERRED EMBODIMENTS

Detailed descriptions will now be given of embodiments in accordance with the present invention. In the following embodiments, the descriptions will be given with reference to the accompanying drawings. In each drawing, different scales will be applied to difference layers or members in order to make the layers or members more easily viewable in the drawings.

(Structure of a liquid crystal device)

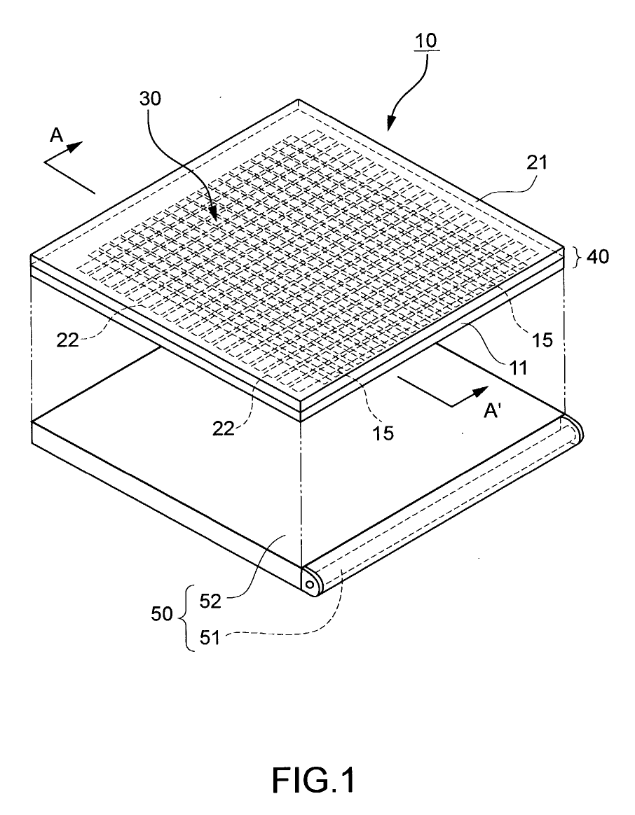

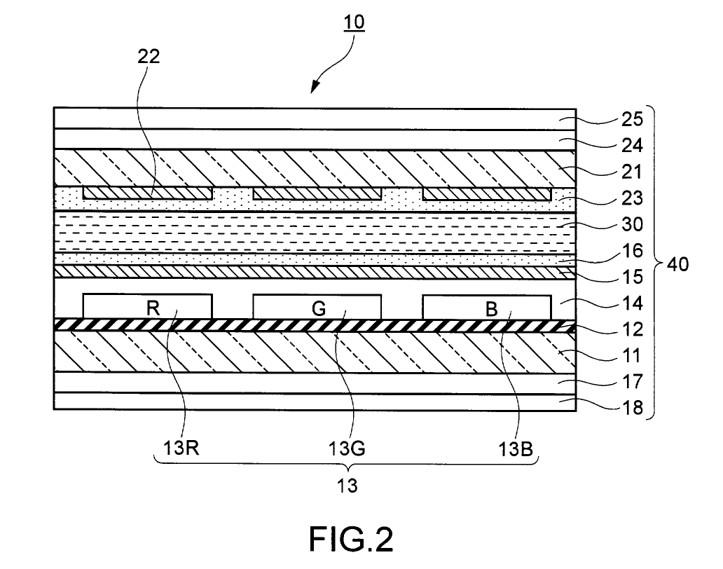

In conjunction with FIG. 1 and FIG. 2, the structure of a transflective liquid crystal device according to an embodiment of the present invention will be explained. In this embodiment, an example in which the present invention has been applied to a passive matrix liquid crystal device will be shown.

FIG. 1 is a schematic perspective view showing an entire construction of the transflective liquid crystal device according to this embodiment. FIG. 2 is a partial schematic sectional view of the transflective liquid crystal device according to this embodiment, and shows a liquid crystal cell of the transflective liquid crystal device shown in FIG. 1 taken along plane A-A′. In FIG. 1 and FIG. 2, the upper side is the observer's side (viewing side).

As shown in FIG. 1 and FIG. 2, a transflective liquid crystal device 10 according to this embodiment is equipped with a liquid crystal cell 40 formed of a color filter substrate (lower substrate) 11 and an opposing substrate (upper substrate) 21 that are opposedly disposed, and a liquid crystal layer 30 (not shown in FIG. 1) sandwiched between these color filter substrate 11 and the opposing substrate 21, and a backlight (illuminating device) 50 disposed at the opposite side from the viewing side of the liquid crystal cell 40.

The color filter substrate 11 is formed of glass, a transparent resin, or the like, and a cholesteric reflective layer 12, a pigment dispersion type color filter 13, an overcoating layer 14, a transparent electrode 15, and an alignment layer 16 are deposited in order on the inner surface of the color filter substrate 11. A lower retardation film 17 and a lower polarizer 18 are bonded in order to the outer surface of the color filter substrate 11. The opposing substrate 21 is formed of glass, a transparent resin, or the like, and has a transparent electrode 22 and an alignment layer 23 deposited in order on the inner surface thereof, an upper retardation film 24 and an upper polarizer 25 being bonded in order to the outer surface thereof. These color filter substrate 11 and the opposing substrate 21 are bonded through the intermediary of a sealing material (not shown) formed on the peripheral portion of each substrate. In FIG. 1, of the layers formed on the color filter substrate 11 and the opposing substrate 21, only the transparent electrode is taken out and shown.

The backlight 50 includes a light source 51 formed of a cold-cathode tube or the like, and a light guide plate 52 having a structure that guides the light emitted from the light source 51 toward an observer so as to efficiently apply the light from the light source 51 to the liquid crystal cell 40.

To be more specific, the cholesteric reflective layer 12 provided on the inner surface of the color filter substrate 11 is formed of at least three different cholesteric liquid crystal layers that individually selectively reflect red, green, and blue circular polarized lights having the same direction of rotation so as to selectively reflect circular polarized lights in substantially entire range (white) of visible light having a particular direction of rotation and to transmit other lights. Furthermore, the cholesteric reflective layer 12 is configured to reflect a part of and transmit a part of the circular polarized light having a particular direction of rotation in the substantially entire range of visible lights rather than reflecting all circular polarized lights having a particular direction of rotation in the substantially entire range of visible lights, thus functioning as a transflective layer. The light transmitted through the polarizers 18 and 25 is a visible light, so that only the circular polarized light having a particular direction of rotation among the lights incident upon the cholesteric reflective layer 12 is selectively reflected by the cholesteric reflective layer 12, independently of the wavelength.

The color filter substrate 11 and the opposing substrate 21 are individually provided with a plurality of transparent electrodes 15 and 22 that are made of indium tin oxide (ITO) or the like formed in stripes to apply voltage to the liquid crystal layer 30. The transparent electrodes 15 and the transparent electrodes 22 extend in directions that intersect with each other, an area where each transparent electrode 15 and each transparent electrode 22 intersect forms one dot. The area where many dots are arranged in a matrix pattern provides a display area.

The color filter 13 is equipped with colored layers 13R, 13G, and 13B that have been colored to red (R), green (G), and blue (B), the colored layers 13R through 13B being periodically provided in correspondence with the dots. In the transflective liquid crystal device 10, three dots that include these red, green, and blue colored layers 13R through 13B enable the display of one pixel to be effected.

Formed on the color filter 13 is the overcoating layer 14 that is made of an organic film or the like and serves to planarize the surface of the color filter substrate 11 on which the color filter 13 is formed and to protect the colored layers 13R through 13B of the color filter 13.

The alignment layers 16 and 23 are formed on the surfaces of the color filter substrate 11 and the opposing substrate 12 that are closer to the liquid crystal layer 30 in order to control the orientation of the liquid crystal molecules in the liquid crystal layer 30 in the non-selection voltage application mode. Examples for the alignment layers 16 and 23 are those made of orientational polymers, such as polyimide, the surfaces thereof being provided with rubbing treatment.

In this embodiment, whether display is performed in the reflective mode or the transmissive mode, elliptic polarized light having a particular direction of rotation is incident upon the liquid crystal layer 30.

To be more specific, the upper polarizer 25 and the upper retardation film 24 are provided on the outer surface of the opposing substrate 21 as the upper elliptic polarized light introducing device to cause the elliptic polarized light having a particular direction of rotation to be incident upon the liquid crystal layer 30 when display is carried out in the reflective mode. Similarly, the lower polarizer 18 and the lower retardation film 17 are provided on the outer surface of the color filter substrate 11 as the lower elliptic polarized light introducing device to cause the elliptic polarized light having a particular direction of rotation to be incident upon the liquid crystal layer 30 when display is carried out in the transmissive mode. In this case, the lower polarizer 18 and the upper polarizer 25 are both configured to transmit only the linear polarized light having a polarization axis in a particular direction, while absorbing any other light. The lower retardation film 17 and the upper retardation film 24 are configured to convert the linear polarized light that has been transmitted through the lower polarizer 18 and the upper polarizer 25 into the elliptic polarized light having a particular direction of rotation. These are combined to allow the elliptic polarized light having the particular direction of rotation to enter the liquid crystal layer 30 whether the display is performed in the reflective mode or the transmissive mode.

There are no particular restrictions on the retardation films 17 and 24 as long as they are able to convert linear polarized light into elliptic polarized light. However, a ¼-wavelength film is preferably used for the lower retardation film 17. The ¼-wavelength film is ideally used as the lower retardation film 17 because it is capable of converting the linear polarized light that has transmitted through the lower polarizer 18 into circular polarized light in particular among elliptic polarized light in a broader sense, thus permitting the most efficient use of light. The upper retardation film 24 may be required to provide a function for color compensation in some cases. Hence, a retardation film having an arbitrary phase difference may be selected.

The above outlines the construction of the transflective liquid crystal device 10 according to this embodiment. The embodiment utilizes the cholesteric reflective layer 12 as the transflective layer, and causes elliptic polarized light to be incident upon the liquid crystal layer 30 to effect display. There is a marked difference between a related art transflective layer using a metal film or the like and the cholesteric reflective layer 12. When elliptic polarized light is reflected, its direction of rotation is inverted in the transflective layer formed of a metal film, whereas the elliptic polarized light can be reflected without causing the direction of rotation to change in the cholesteric reflective layer 12.

Thus, in this embodiment, the elliptic polarized light is entered in the liquid crystal layer 30 to perform display. Hence, enhancing or optimizing the display characteristics, including brightness and contrast, in both reflective mode and transmissive mode requires a liquid crystal mode different from the TN mode, STN mode, or the like adapted to effect display by making linear polarized light enter the liquid crystal layer. However, an optimum liquid crystal mode and a display mode under the low twist condition in which the twist angle of the liquid crystal layer 30 is below 150° are different from those under the high twist condition in which the twist angle of the liquid crystal layer 30 ranges from 150° to 270°.

(Optimum Liquid Crystal Mode Under the Low Twist Condition)

First, an optimum liquid crystal mode under the low twist condition will be explained.

Under the low twist condition, as described in the Summary of the Invention section of this application, the twist angle of the liquid crystal layer 30 is preferably set to 0 to 12° and the Δn·d value to 0.37±0.05 mm. Alternatively, the twist angle of the liquid crystal layer 30 is preferably set to 130±20° and the Δn·d value to 0.76±0.05 μm. Setting the liquid crystal mode as described above makes it possible to enhance or optimize the display characteristics, such as brightness and contrast, in both reflective mode and transmissive mode.

Furthermore, when the Δn·d value of the liquid crystal layer 30 is specified as shown above, the direction of rotation of the elliptic polarized light incident upon the liquid crystal layer 30 in the non-selection voltage application mode can be inverted when the elliptic polarized light exits from the liquid crystal layer 30. In contrast to this, in the selection voltage application mode, the liquid crystal molecules in the liquid crystal layer 30 change their orientation along the longitudinal electric field generated between the transparent electrodes 15 and 22. This decreases the phase difference of the liquid crystal layer 30, and the direction of rotation of the elliptic polarized light incident upon the liquid crystal layer 30 does not change after being transmitted through the liquid crystal layer 30. This can be utilized to effect display under the low twist condition.

Further preferably, the elliptic polarized light incident upon the liquid crystal layer 30 through the opposing substrate 21 and the circular polarized light selectively reflected by the cholesteric reflective layer 12 have different directions of rotation. This arrangement is ideal because it permits further enhancement or optimization of the display characteristics, such as brightness and contrast, in both reflective mode and transmissive mode.

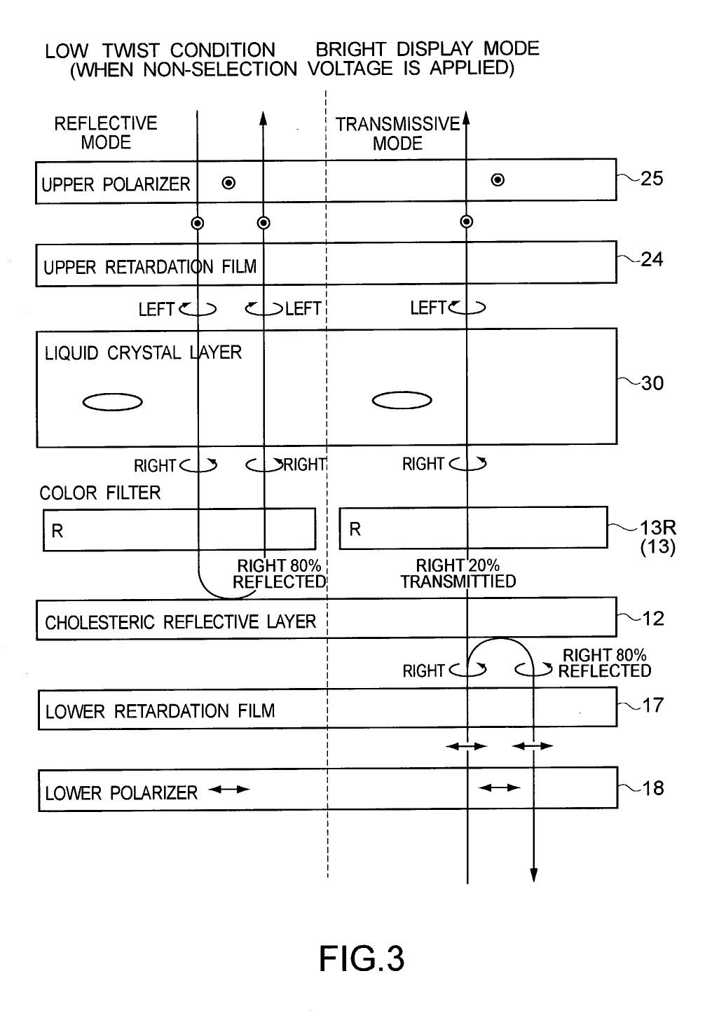

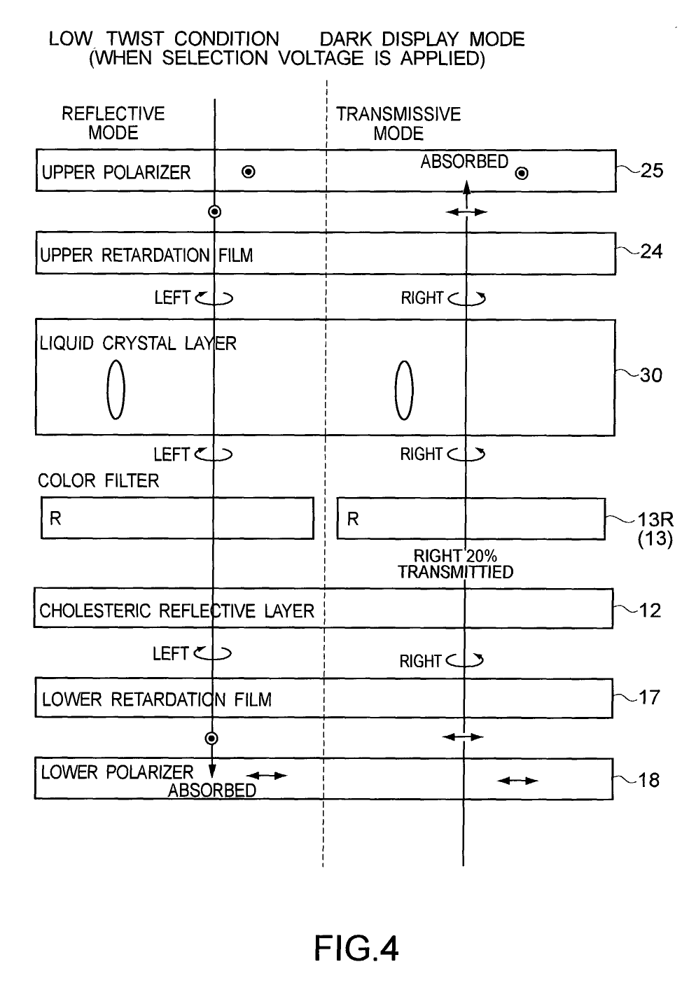

In conjunction with FIG. 3 and FIG. 4, the descriptions will now be given of the display mode under the low twist condition of the transflective liquid crystal device 10 according to the embodiment. FIG. 3 and FIG. 4 respectively show the essential section of the transflective liquid crystal device 10 according to this embodiment, and they illustrate the display modes set when a non-selection voltage is applied and a selection voltage is applied, respectively.

In the following explanation, a dot in which the red colored layer 13R of the color filter 13 has been formed will be taken as an example. Exactly the same display mode applies to dots in which colored layers of other colors are formed.

As described above, the cholesteric reflective layer 12 is constructed to reflect a part of and transmit a part of the circular polarized light having a particular direction of rotation among the light entering the cholesteric reflective layer 12. It is possible to appropriately design the direction of rotation of the circular polarized light to be selectively reflected and the reflectivity and transmissivity thereof. It is assumed that the cholesteric reflective layer 12 is configured such that it selectively reflects right circular polarized light among the light incident upon the cholesteric reflective layer 12, the reflectivity being 80% and the transmissivity being 20%. The cholesteric reflective layer 12 having such a construction is adapted to transmit 100% the circular polarized light (the left circular polarized light) having a different direction of rotation from the right circular polarized light to be selectively reflected.

As described above, an arrangement is preferably made such that the elliptic polarized light incident upon the liquid crystal layer 30 through the opposing substrate 21 has a different direction of rotation from that of the circular polarized light selectively reflected by the cholesteric reflective layer 12. Therefore, the upper elliptic polarized light introducing device (upper polarizer 25 and the upper retardation film 24) is configured to generate left elliptic polarized light. For example, an arrangement is made such that the upper polarizer 25 selectively transmits only the linear polarized light having a polarization axis perpendicular to the paper surface, while the upper retardation film 24 converts the linear polarized light that has been transmitted through the upper polarizer 25 into left elliptic polarized light.

In the case of the bright display in the transmissive mode, the light emitted from the backlight 50 must transmit through the cholesteric reflective layer 12. Therefore, the lower elliptic polarized light introducing device (the lower polarizer 18 and the lower retardation film 17) is configured to generate right circular polarized light. For example, an arrangement is made such that the lower polarizer 18 selectively only transmits the linear polarized light having a polarization axis parallel to the paper surface, while the lower retardation film 17 converts the linear polarized light that has been transmitted through the lower polarizer 18 into right circular polarized light.

With the aforesaid arrangement, the bright display can be obtained whether display is performed in the reflective mode or the transmissive mode when a non-selection voltage is applied, and the dark display can be obtained whether display is performed in the reflective mode or the transmissive mode when a selection voltage is applied.

In conjunction with FIG. 3, the detailed descriptions will now be given of the display mode when a non-selection voltage is applied.

To perform display in the reflective mode when a non-selection voltage is applied, of the external light incident upon the liquid crystal cell 40 from the observer's side, only the linear polarized light having a polarization axis perpendicular to the paper surface is transmitted through the upper polarizer 25, and is converted into left elliptic polarized light by the upper retardation film 24, so that the left elliptic polarized light enters the liquid crystal layer 30.

When a non-selection voltage is applied, the orientation of the liquid crystal molecules in the liquid crystal layer 30 is controlled by the alignment layers 16 and 23, and they are arranged such that they are twisted by 0 to 12° or 130±20°, with their major axes directed substantially horizontal to the substrate surfaces. As mentioned above, the left elliptic polarized light incident upon the liquid crystal layer 30 is converted into right circular polarized light and exits from the liquid crystal layer 30.

Of the right circular polarized light emergent from the liquid crystal layer 30, only red right circular polarized light is transmitted through the colored layer 13R of the color filter 13 and enters the cholesteric reflective layer 12. Since the cholesteric reflective layer 12 is configured to reflect 80% of the right circular polarized light, 80% of the red right circular polarized light incident upon the cholesteric reflective layer 12 is reflected by the cholesteric reflective layer 12. As described above, the cholesteric reflective layer 12 is able to reflect circular polarized light without changing its direction of rotation, so that the red right circular polarized light incident upon the cholesteric reflective layer 12 is reflected with its direction of rotation unchanged, transmitted again through the colored layer 13R of the color filter 13, and incident upon the liquid crystal layer 30.

The red right circular polarized light incident upon the liquid crystal layer 30 is converted into left elliptic polarized light by the liquid crystal layer 30, and exits from the liquid crystal layer 30. The red left elliptic polarized light emergent from the liquid crystal layer 30 is converted by the upper retardation film 24 into the linear polarized light having a polarization axis perpendicular to the paper surface, then transmitted through the upper polarizer 25, and emitted toward an observer. This provides the bright display (red display).

On the other hand, to perform display in the transmissive mode when a non-selection voltage is applied, of the light incident upon the liquid crystal cell 40 from the back light 50, only the linear polarized light having the polarization axis parallel to the paper surface is transmitted through the lower polarizer 18 and converted into right circular polarized light by the lower retardation film 17. Thus, the right circular polarized light enters the cholesteric reflective layer 12.

The cholesteric reflective layer 12 is configured to transmit 20% of the right circular polarized light, thus allowing 20% of the right circular polarized light incident upon the cholesteric reflective layer 12 to be transmitted through the cholesteric reflective layer 12. Of the right circular polarized light transmitted through the cholesteric reflective layer 12, only the red right circular polarized light is transmitted through the colored layer 1 3R of the color filter 13 and enters the liquid crystal layer 30.

As described above, the red right circular polarized light incident upon the liquid crystal layer 30 when a non-selection voltage is applied is converted into left elliptic polarized light and emitted from the liquid crystal layer 30. Then, the red left elliptic polarized light emergent from the liquid crystal layer 30 is converted into linear polarized light having a polarization axis perpendicular to the paper surface by the upper retardation film 24, then transmitted through the upper polarizer 25 and emitted toward the observer. This provides the bright display (red display).

When display is performed in the transmissive mode under the application of a non-selection voltage, 80% of the right circular polarized light incident upon the cholesteric reflective layer 12 is reflected and returned to the backlight 50. Since the cholesteric reflective layer 12 is able to reflect circular polarized light without changing the direction of rotation thereof, the circular polarized light reflected by the cholesteric reflective layer 12 enters the lower retardation film 17 as the right circular polarized light. Then, the right circular polarized light incident upon the lower retardation film 17 is converted into linear polarized light having a polarization axis parallel to the paper surface by the lower retardation film 17, so that the linear polarized light can be transmitted through the lower polarizer 18. Thus, the linear polarized light having the same polarization axis as the transmission axis of the lower polarizer 18 is emitted from the color filter substrate 11 to the outside of the liquid crystal cell 40. This light can be introduced back into the liquid crystal cell 40 to reuse it for display by reflecting the light back to the liquid crystal cell 40 by, for example, a reflector provided on the backlight 50.

When display is performed in the reflective mode under the application of a non-selection voltage, 20% of the right circular polarized light incident upon the cholesteric reflective layer 12 is transmitted through the cholesteric reflective layer 12. This light can be also introduced back into the liquid crystal cell 40 after it is emitted from the liquid crystal cell 40 once through the color filter substrate 11. This light contributes to the display, so that bright display in the reflective mode can be also maintained.

In conjunction with FIG. 4, the display mode when a selection voltage is applied is described in detail below.

To perform display in the reflective mode under the application of a selection voltage, left elliptic polarized light enters the liquid crystal layer 30, as in the case of the non-selection voltage application mode. When the selection voltage is applied, the liquid crystal molecules in the liquid crystal layer 30 change their orientation along a longitudinal electric field generated between the transparent electrodes 15 and 22, and the phase difference in the liquid crystal layer 30 reduces. Thus, the left elliptic polarized light that has entered the liquid crystal layer 30 is converted substantially into left circular polarized light with its direction of rotation unchanged, and emitted from the liquid crystal layer 30.

The left circular polarized light that has been emitted from the liquid crystal layer 30 is transmitted through the color filter 13, then enters the cholesteric reflective layer 12. Since the cholesteric reflective layer 12 is configured to transmit 100% of left circular polarized light, all the left circular polarized light incident upon the cholesteric reflective layer 12 is transmitted through the cholesteric reflective layer 12. Further, the left circular polarized light that has been transmitted through the cholesteric reflective layer 12 is converted into linear polarized light having a polarization axis perpendicular to the paper surface by the lower retardation film 17, then absorbed by the lower polarizer 18; hence, the light is not emitted toward an observer. This provides the dark display.

On the other hand, when display is performed in the transmissive mode under the application of a selection voltage, right circular polarized light enters the liquid crystal layer 30, as in the non-selection voltage application mode. However, the phase difference of the liquid crystal layer 30 reduces under the application of the selection voltage, so that the right circular polarized light incident upon the liquid crystal layer 30 exits from the liquid crystal layer 30 with the direction of rotation unchanged but with slightly changed ellipticity. The right elliptic polarized light that has left the liquid crystal layer 30 is converted into linear polarized light having a polarization axis parallel to the paper surface by the upper retardation film 24, then absorbed by the upper polarizer 25. Therefore, the light will not be emitted toward the observer, resulting in the dark display.

Even if an arrangement is made such that, of the right circular polarized light incident upon the cholesteric reflective layer 12 from the backlight 50 side, 80% of the light reflected by the cholesteric reflective layer 12 is emitted from the liquid crystal cell 40 once through the color filter substrate 11, then introduced back into the liquid crystal cell 40, the light will be eventually absorbed by the upper polarizer 25, causing no particular harm to the dark display when the display is effected in the transmissive mode under the application of the selection voltage.

By effecting the display as explained above, the same display mode can be used for both reflective display and transmissive display. When attention is focused on the bright display in the transmissive mode, a part of the light incident from the lower substrate side is not absorbed by the upper polarizer and substantially all light that has been transmitted through the cholesteric reflective layer 12 contributes to display, as in the case of the related art transflective liquid crystal device. Furthermore, the arrangement is such that the light reflected by the cholesteric reflective layer 12 and directed toward the opposite side from the observer (toward the back light 50) can be reused to provide display. In the above explanation, for the purpose of convenience, the case where the reflectivity and the transmissivity of the right circular polarized light selectively reflected by the cholesteric reflective layer 12 are 80% and 20%, respectively, has been described. However, the percentages of the reflectivity and transmissivity of the circular polarized light selectively reflected can be changed as desired. Independently of the percentages, the combination of the advantage in that maximum utilization of the circular polarized light that has been transmitted through the cholesteric reflective layer 12 is possible and the advantage in that the circular polarized light reflected by the cholesteric reflective layer 12 can be reused for display makes it possible to accomplish the transflective liquid crystal device 10 that is capable of providing enhanced brightness of display in the transmissive mode while maintaining the brightness of the display in the reflective mode, exhibiting superior visibility.

(Liquid Crystal Mode Under the High Twist Condition)

The descriptions will now be given of an optimum liquid crystal mode under the high twist condition.

Under the high twist condition wherein the twist angle of the liquid crystal layer 30 ranges from 150° to 270°, the liquid crystal mode is preferably set so that the Δn·d value is represented by the following expression (1) when the twist angle is denoted by θ (°), as described in the Summary of the Invention section of this application. Setting the liquid crystal mode as set forth above makes it possible to enhance or optimize the display characteristics, such as brightness and contrast, in both reflective mode and transmissive mode.

Δn·d value (μm)=−6.7×10⁻⁶×θ²4.3×10⁻³×θ+0.39±0.1. (1)

Under the high twist condition, it is possible to make an arrangement such that the liquid crystal layer 30 inverts the direction of rotation of the incident elliptic polarized light in the non-selection voltage application mode, while it does not change the direction of rotation of the incident elliptic polarized light in the selection voltage application mode, as in the case of the low twist condition. This configuration, however, can be reversed.

Thus, under the high twist condition, display is effected by utilizing the liquid crystal layer 30 that inverts the direction of rotation of incident elliptic polarized light in one of the non-selection voltage application mode and the selection voltage application mode, while it does not change the direction of rotation of the incident elliptic polarized light in the other mode.

Preferably, under the high twist condition, an arrangement is made such that the elliptic polarized light incident upon liquid crystal layer 30 through the opposing substrate 21 and the circular polarized light selectively reflected by the cholesteric reflective layer 12 have the same direction of rotation. This arrangement is ideal because it permits further optimization of display characteristics, such as brightness and contrast, in both reflective and the transmissive mode.

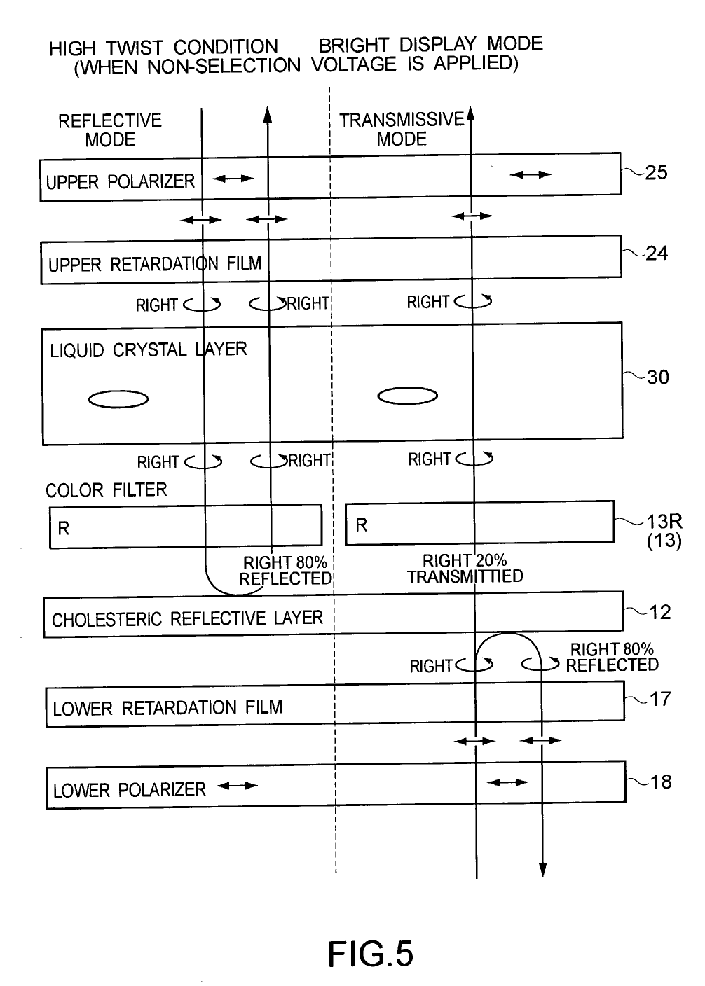

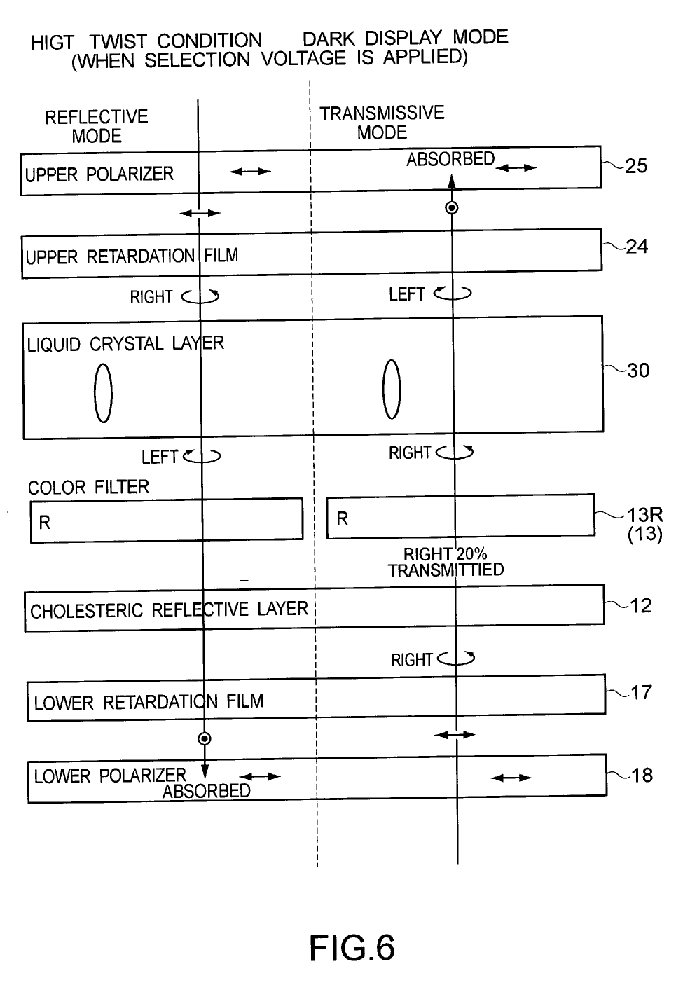

In conjunction with FIG. 5 and FIG. 6, the display mode under the high twist condition in the construction wherein all elliptic polarized light incident upon the liquid crystal layer 30 through the opposing substrate 21 and the circular polarized light selectively reflected by the cholesteric reflective layer 12 have different directions of rotation will now be described. FIG. 5 and FIG. 6 correspond to FIG. 3 and FIG. 4 used for explaining the display mode under the low twist condition, and illustrate the display modes under the application of the non-selection voltage application mode and the selection voltage application mode, respectively.

As in the case of the low twist condition, a dot in which the red colored layer 13R of the color filter 13 is used as an example for the description. It is assumed that, as in the case of the low twist condition, the cholesteric reflective layer 12 is configured such that it selectively reflects right circular polarized light out of the light incident upon the cholesteric reflective layer 12, the reflectivity thereof being 80% and the transmissivity thereof being 20%.

Under the high twist condition, it is preferred to make an arrangement such that the elliptic polarized light incident upon the liquid crystal layer 30 through the opposing substrate 21 and the circular polarized light selectively reflected by the cholesteric reflective layer 12 have the same direction of rotation, which is different from the case of the low twist condition. For this reason, an arrangement is made such that the upper elliptic polarized light introducing device (the upper polarizer 25 and the upper retardation film 24) generates right elliptic polarized light. For example, an arrangement is made such that the upper polarizer 25 selectively transmits only the linear polarized light having a polarization axis parallel to the paper surface, while the upper retardation film 24 converts the linear polarized light that has been transmitted through the upper polarizer 25 into right elliptic polarized light.

Furthermore, as in the case of the low twist condition, for the bright display when display is effected in the transmissive mode, it is necessary for the light emergent from the backlight 50 to be transmitted through the cholesteric reflective layer 12. Hence, an arrangement is made such that the lower elliptic polarized light introducing device (the lower polarizer 18 and the lower retardation film 17) generates right circular polarized light.

The aforesaid arrangement enables the bright display to be obtained whether the display is effected in the reflective mode or the transmissive mode under the application of the non-selection voltage, and the dark display to be obtained whether the display is effected in the reflective mode or the transmissive mode under the application of the selection voltage.

In conjunction with FIG. 5, detailed descriptions are given below of the display mode under the application of the non-selection voltage.

To perform display in the reflective mode when the non-selection voltage is applied, of the light incident upon the liquid crystal cell 40 from the observer's side, only the linear polarized light having a polarization axis parallel to the paper surface is transmitted through the upper polarizer 25, and converted into right elliptic polarized light by the upper retardation film 24, so that the right elliptic polarized light enters the liquid crystal layer 30. In this case, the liquid crystal layer 30 is configured such that it does not change the direction of rotation of the incident elliptic polarized light in the non-selection voltage application mode. Hence, the right elliptic polarized light incident upon the liquid crystal layer 30 is emitted from the liquid crystal layer 30 as the right circular polarized light having the same direction of rotation.

Of the right circular polarized light emergent from the liquid crystal layer 30, the red right circular polarized light that has been transmitted through the colored layer 13R of the color filter 13 is reflected 80% by the cholesteric reflective layer 12 and incident upon the liquid crystal layer 30 again, while retaining the same direction of rotation, as in the case of the application of the non-selection voltage under the low twist condition. The liquid crystal layer 30 is configured to not change the direction of rotation of the incident elliptic polarized light when the non-selection voltage is applied. Therefore, the red right circular polarized light that has entered the liquid crystal layer 30 is emitted from the liquid crystal layer 30 with its direction of rotation unchanged.

The red right elliptic polarized light emergent from the liquid crystal layer 30 is converted by the upper retardation film 24 into linear polarized light having a polarization axis parallel to the paper surface, then transmitted through the upper polarizer 25, and emitted toward an observer. This provides the bright display (red display).

On the other hand, to perform display in the transmissive mode when the non-selection voltage is applied, the red right circular polarized light that has been transmitted through the cholesteric reflective layer 12 and the colored layer 13R of the color filter 13 enters the liquid crystal layer 30, as in the case of the application of the non-selection voltage under the low twist condition. The liquid crystal layer 30 is configured not to change the direction of rotation of the incident elliptic polarized light when the non-selection voltage is applied. Therefore, the red right circular polarized light that has entered the liquid crystal layer 30 leaves the liquid crystal layer 30 in the form of right elliptic polarized light having the same direction of rotation. Furthermore, the red right elliptic polarized light emergent from the liquid crystal layer 30 is converted into linear polarized light having the polarization axis parallel to the paper surface by the upper retardation film 24, then transmitted through the upper polarizer 25 and emitted toward the observer. This provides the bright display (red display).

As in the case of the low twist condition, when display is performed in the transmissive mode under the application of the non-selection voltage, 80% of the right circular polarized light incident upon the cholesteric reflective layer 12 is reflected and returned to the backlight 50. However, the reflected light can be emitted from the liquid crystal cell 40 once through the color filter substrate 11, then introduced back into the liquid crystal cell 40 again to reuse it.

When display is performed in the reflective mode under the application of the non-selection voltage, 20% of the right circular polarized light incident upon the cholesteric reflective layer 12 is transmitted through the cholesteric reflective layer 12. This light can be also introduced back into the liquid crystal cell 40 after it is emitted from the liquid crystal cell 40 once through the color filter substrate 11. This light contributes to the display, so that bright display in the reflective mode can be also maintained.

In conjunction with FIG. 6, detailed descriptions are given below of the display mode under the application of the selection voltage.

To perform display in the reflective mode under the application of the selection voltage, right elliptic polarized light enters the liquid crystal layer 30, as in the case of the non-selection voltage application mode. The liquid crystal layer 30 is configured to invert the direction of rotation of the incident elliptic polarized light when the selection voltage is applied. Thus, the right elliptic polarized light that has entered the liquid crystal layer 30 is converted into left circular polarized light, and emitted from the liquid crystal layer 30.

The left circular polarized light that has been emitted from the liquid crystal layer 30 is transmitted through the color filter 13, then enters the cholesteric reflective layer 12. Since the cholesteric reflective layer 12 is configured to transmit 100% of left circular polarized light, all the left circular polarized light incident upon the cholesteric reflective layer 12 is transmitted through the cholesteric reflective layer 12. Further, the left circular polarized light that has been transmitted through the cholesteric reflective layer 12 is converted into linear polarized light having a polarization axis perpendicular to the paper surface by the lower retardation film 17, then absorbed by the lower polarizer 18. Hence, the light is not emitted toward an observer. This provides a dark display.

On the other hand, when display is performed in the transmissive mode under the application of the selection voltage, right circular polarized light enters the liquid crystal layer 30, as in the non-selection voltage application mode. However, the liquid crystal layer 30 is configured to invert the direction of rotation of the incident elliptic polarized light when the selection voltage is applied, so that the right circular polarized light incident upon the liquid crystal layer 30 is converted into left elliptic polarized light and emitted from the liquid crystal layer 30.

The left elliptic polarized light emergent from the liquid crystal layer 30 is converted into linear polarized light having the polarization axis perpendicular to the paper surface by the upper retardation film 24, then absorbed by the upper polarizer 25. Since the light is not emitted toward the observer, the dark display results.

As in the case of the low twist condition, even if an arrangement is made such that, of the right circular polarized light incident upon the cholesteric reflective layer 12, 80% of the light reflected by the cholesteric reflective layer 12 goes out of the liquid crystal cell 40 once from the color filter substrate 11 side, then it is introduced back into the liquid crystal cell 40, the light will be eventually absorbed by the upper polarizer 25, when display is performed in the transmissive mode under the application of the selection voltage, posing no problem in particular for the dark display.

By effecting the display as explained above, the same display mode can be used for both reflective display and transmissive display also under the high twist condition. When attention is focused on the bright display in the transmissive mode, substantially all light that has been transmitted through the cholesteric reflective layer 12 contributes to display, and the light reflected by the cholesteric reflective layer 12 can be reused for display as in the case of the low twist condition. This makes it possible to accomplish the transflective liquid crystal device 10 that is capable of providing improved brightness of display in the transmissive mode while maintaining the brightness of the display in the reflective mode, exhibiting superior visibility.

As explained above, in this embodiment, under both low twist condition and high twist condition, the cholesteric reflective layer 12 is used as the transflective layer, the light incident upon the liquid crystal layer 30 is elliptic polarized light, and the liquid crystal layer 30 is configured such that it inverts the direction of rotation of incident elliptic polarized light in one of the non-selection voltage application mode and the selection voltage application mode, while it does not change the direction of rotation of the incident elliptic polarized light in the other mode. This arrangement allows the same display mode to be used for the reflective display and the transmissive display, making it possible to prevent the transmissive mode of a display mechanism from being dark. Furthermore, the light reflected toward the backlight 50 by the selective reflection of the cholesteric reflective layer 12 can be reused without the need to modify the related art construction of the outer surface side of the color filter substrate 11, permitting improved brightness of display in the transmissive mode to be achieved. This makes it possible to accomplish the transflective liquid crystal device 10 that is capable of providing enhanced brightness of display in the transmissive mode while maintaining the brightness of the display in the reflective mode, exhibiting superior visibility.

Furthermore, in the transflective liquid crystal device 10 according to the present embodiment, the liquid crystal mode (twist angle, Δn·d value) is enhanced or optimized, so that the display characteristics, such as brightness and contrast, can be optimized in both reflective mode and transmissive mode, thus enabling the transflective liquid crystal device 10 exhibiting superior display quality to be provided.

In this embodiment, the descriptions have been given of only the example in which the bright display is effected in the non-selection voltage application mode, while the dark display is effected in the selection voltage application mode under both low twist condition and high twist condition. It is possible, however, to reverse the bright display and the dark display while retaining the same configurations of the polarizers 18 and 25, the liquid crystal layer 30, and the cholesteric reflective layer 12, if the upper retardation film 24 is provided with a function for color compensation or a plurality of retardation films are used for each of the retardation films 17 and 24.

In this embodiment, the color display is effected by transmitting light through the pigment dispersion type color filter 13 whether display is effected in the reflective mode or the transmissive mode. However, the present invention is not limited thereto. Since the cholesteric reflective layer has the characteristic in which it selectively reflects circular polarized light of a particular wavelength having a particular direction of rotation, a cholesteric color filter can be created by pattern-forming three types of cholesteric reflective layers, which are adapted to selectively reflect red light, green light, and blue light among the circular polarized light having a particular direction of rotation, in association with dots for red, green, and blue display. Hence, to carry out display in the reflective mode, it is possible to effect the display by reflecting particular color light for each dot by a cholesteric color filter. However, to carry out display in the transmissive mode, circular polarized light of colors other than those desired to be displayed is also transmitted through the cholesteric color filter. For this reason, it is necessary to provide another pigment dispersion type color filter having the same color pattern as that of the cholesteric color filter at the viewing side of the cholesteric color filter.

Furthermore, in this embodiment, the descriptions have been given of the case where the color filter substrate is positioned at the backlight side. However, the present invention is not limited thereto. The present invention can be applied also to a case where the color filter substrate is positioned at the observer side. However, it is necessary to form a cholesteric reflective layer on the opposing substrate if the color filter substrate is disposed at the observer side.

Moreover, the present invention can be applied also to a transflective liquid crystal device of any drive method, including an active matrix liquid crystal device using a TFT (Thin Film Transistor) device or a TFD (Thin Film Diode) device as a switching device, in addition to a passive matrix liquid crystal device.

The present invention is particularly suitably applied to a transflective liquid crystal device. The optimum liquid crystal mode explained in the embodiment can be applied also to a reflective liquid crystal device provided with a cholesteric reflective layer as a reflective layer.

In this case, light is not incident upon the liquid crystal layer through the lower substrate, thus obviating the need for the backlight and the lower elliptic polarized light introducing device (the lower polarizer and the lower retardation film). As in the case of the present embodiment, the cholesteric reflective layer may be configured such that a part of the circular polarized light selectively reflected is reflected and a part thereof is transmitted. It is preferred, however, to fully reflect the circular polarized light selectively reflected so as to supply more outgoing light toward the observer and to enhance the brightness of display, because light is not incident upon the cholesteric reflective layer through the lower substrate. The use of the construction set forth above and the application of the liquid crystal mode explained in the present embodiment to effect the same display as that in the reflective mode according to the present embodiment makes it possible to optimize the display characteristics, such as brightness and contrast, thus enabling a reflective liquid crystal device exhibiting superior display quality.

[Electronic Equipment]

A specific example of electronic equipment provided with the transflective liquid crystal device 10 according to the foregoing embodiment of the present invention will now be described.

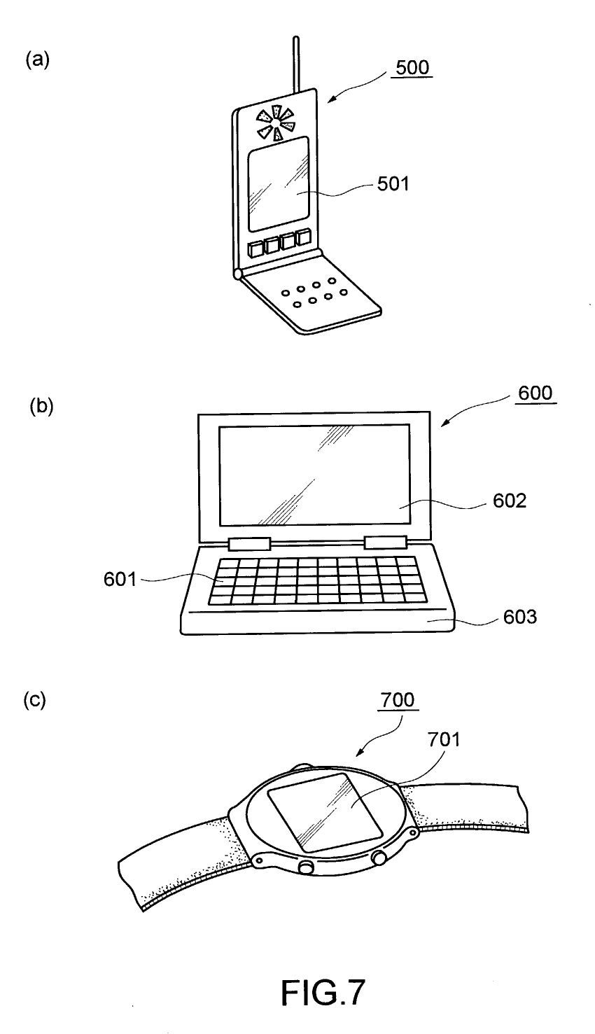

FIG. 7(a) is a perspective view showing an example of a cellular telephone. In FIG. 7(a), reference numeral 500 denotes a cellular telephone main unit, and reference numeral 501 denotes a liquid crystal display unit equipped with the foregoing transflective liquid crystal device 10.

FIG. 7(b) is a perspective view showing an example of a portable information processing apparatus, such as a word processor or personal computer. In FIG. 7(b), reference numeral 600 denotes an information processing apparatus, reference numeral 601 denotes an input unit, such as a keyboard, reference numeral 603 denotes an information processing main unit, and reference numeral 602 denotes a liquid crystal display unit equipped with the transflective liquid crystal device 10.

FIG. 7(c) is a perspective view showing an example of wristwatch type electronic equipment. In FIG. 7(c), reference numeral 700 denotes a watch main body, and reference numeral 701 denotes a liquid crystal display unit equipped with the foregoing transflective liquid crystal device 10.

The electronic equipment shown in FIGS. 7(a) through 7(c) is provided with the transflective liquid crystal device 10 according to the aforesaid embodiment, thus exhibiting superior display characteristics, such as brightness and contrast.

### EXAMPLES

Examples in accordance with the present invention are explained below. In examples 1 and 2, polarized states Eb and Ew of the light to be incident upon a liquid crystal layer should mean the polarized states computed on the basis of the standardized stokes parameters represented on the coordinates of Poincare sphere. The method to compute the polarized states computed on the basis of the standardized stokes parameters represented by the coordinates on the Poincare sphere is disclosed in Japanese Unexamined Patent Publication No. 7-239471.

### Example 1

The study of optimization of display under a low twist condition was carried out as described below.

It is assumed that black display is effected if the light incident upon the cholesteric reflective layer is right circular polarized light. The polarized states Eb of the light to be incident upon a liquid crystal layer when a twist angle q of the liquid crystal layer is changed within the range of 0 to 150° and the Δn·d value is changed within the range of 0.1 to 1.5 are calculated. Similarly, it is assumed that white display is effected when the light incident upon the cholesteric reflective layer is left circular polarized light, and the polarized states Ew of the light to be incident upon the liquid crystal layer when the twist angle q and the Δn·d value of the liquid crystal layer are changed are calculated. The polarized states Eb and Ew are calculated on the light of five colors, namely, the light having a wavelength of 630 nm (red light), the light having a wavelength of 590 nm (orange light), the light having a wavelength of 550 nm (green light), the light having a wavelength of 510 nm (azure light), and the light having a wavelength of 460 nm (blue light).

The polarized state of the light incident upon the liquid crystal layer actually remains unchanged independently of the voltage applied to the liquid crystal layer. Hence, display can be optimized by defining the twist angle θ and the Δn·d value of the liquid crystal layer that minimize the value of a distance ΔE between the polarized states Eb and Ew of the light to be incident upon the liquid crystal layer.

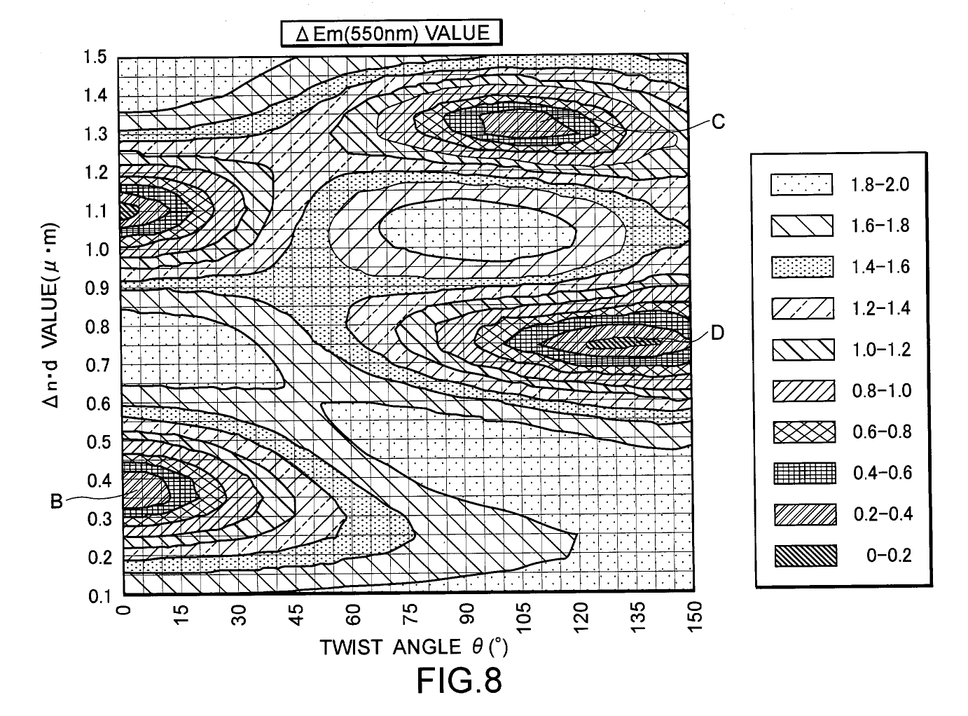

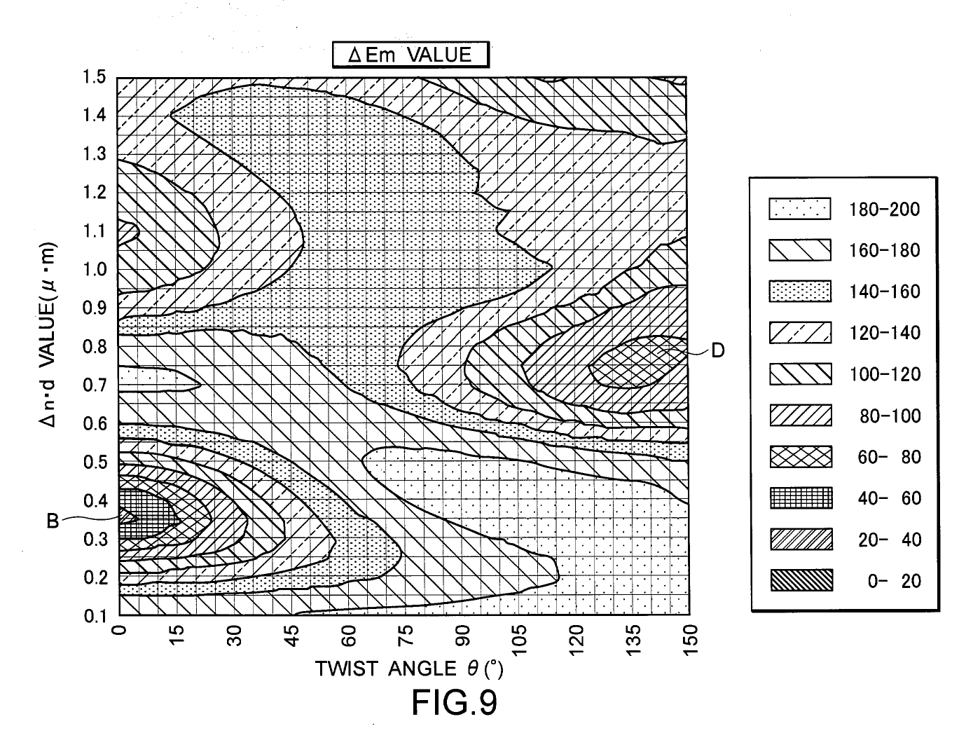

FIG. 8 shows the relationship between the ΔE (550 nm) value of the light having the 550-nm wavelength and the twist angle θ and the Δn·d value of the liquid crystal layer obtained in this example. FIG. 9 shows the relationship between an average value ΔEm of the ΔE value on each color light and the twist angle θ and the Δn·d value of the liquid crystal layer.

When attention is focused on the light having the 550-nm wavelength, there are four regions denoted by symbols A through D where the ΔE value is minimum, as shown in FIG. 8. However, when each color light is considered, out of the regions denoted by A through D, there are only two regions denoted by symbols B and D where the ΔEm value is minimum, as shown in FIG. 9. Hence, the regions denoted by symbols B and D provide the optimum conditions. Specifically, the region represented by symbol B is defined by the twist angle θ of the liquid crystal layer that ranges from 0 to 12° and the Δn·d value thereof that is 0.37±0.05 μm. The region denoted by symbol D is defined by the twist angle of the liquid crystal layer that is 130±20° and the Δn·d value thereof that is 0.76±0.05 μm.

Based on the above results, it has been found that, under a low twist condition in which the twist angle of the liquid crystal layer is below 150°, display characteristics are optimized when the twist angle q of the liquid crystal layer ranges from 0 to 12° and the Δn·d value thereof is 0.37±0.05 mm or when the twist angle θ of the liquid crystal layer is 130±20° and the Δn·d value thereof is 0.76±0.05 μm.

### Example 2

As in the case of Example 1, the polarized states Eb and Ew of the light to be incident upon the liquid crystal layer when the twist angle q of the liquid crystal layer is changed within the range of 150 to 270° and the Δn·d value thereof is changed within the range of 0.3 to 1.2 were calculated to study the enhanced or optimized display under the high twist condition.

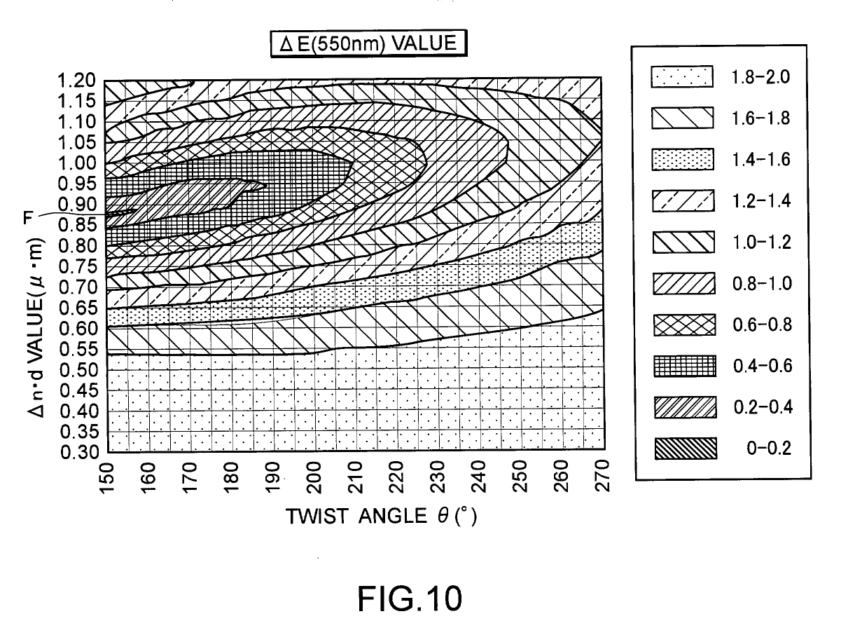

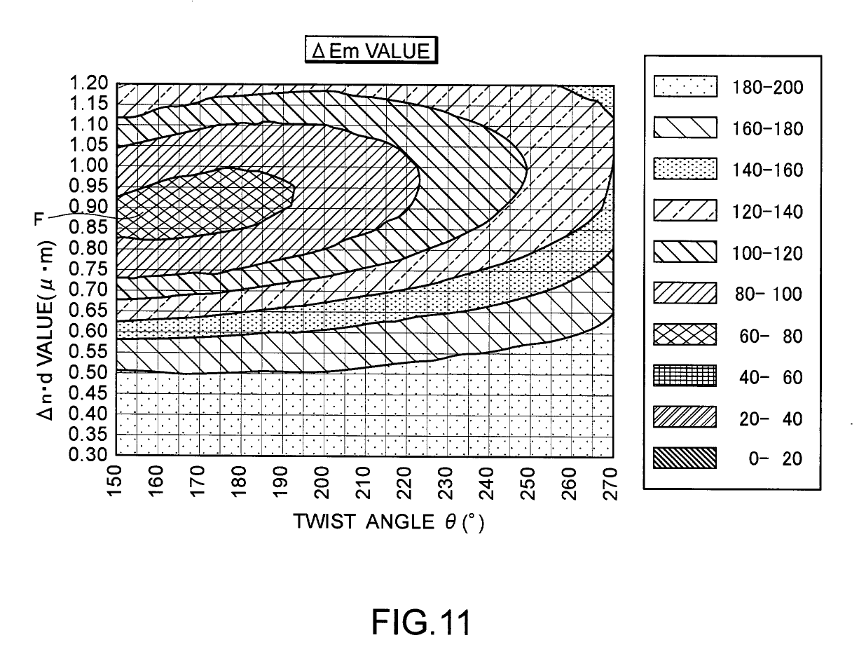

FIG. 10 shows the relationship between the ΔE (550 nm) value of the light having the 550-nm wavelength and the twist angle θ and the Δn·d value of the liquid crystal layer obtained in this example. FIG. 11 shows the relationship between the average value ΔEm of the ΔE value on each color light and the twist angle θ and the Δn·d value of the liquid crystal layer.

As shown in FIG. 10 and FIG. 11, under the high twist condition, the area around the region denoted by symbol F shows relatively small ΔE (550 nm) value and average value ΔEm, although the optimum range is not narrowed down as much as that under the low twist condition in Example 1. The present inventors attempted to represent the relationship between the twist angle and the Δn·d value of the liquid crystal layer in the area around the region denoted by symbol F into an expression, and found that the relationship can be approximated by the expression (1). More specifically, it was found that setting the twist angle and the Δn·d value of the liquid crystal layer so as to satisfy the above expression (1) permits optimized display characteristics to be obtained under the high twist condition in which the twist angle of the liquid crystal layer ranges from 150° to 270°.

### Example 3

A transflective liquid crystal device in accordance with the present invention that has the same construction as the foregoing embodiment was fabricated and the display characteristics of the obtained liquid crystal device were evaluated. Two retardation films for each of the upper retardation film and the lower retardation film were disposed to constitute the liquid crystal device under the conditions shown in Table 1. A monochrome display liquid crystal device was fabricated without providing the pigment dispersion type color filter, and basic characteristics were checked. In Table 1, of the two upper retardation films and lower retardation films, the retardation films on the upper substrate are denoted by symbol 1, while the retardation films on the lower substrate are denoted by symbol 2. The transmission axis of a polarizer and the retardation axis of a phase plate are represented in angles that are positive counterclockwise on the basis of the rubbing axis of the alignment layer on the upper substrate. In this example, the liquid crystal device was constructed under one of the optimum conditions at a low twist, in which the twist angle of the liquid crystal layer is 0° and the Δn·d value is 0.37 μm.

TABLE 1

| | | |
|---|---|---|
| Upper Polarizer | Transmission Axis | 30° |
| Upper Retardation Film | Δn · d | 110 nm |
| 1 | Retardation Axis | 4° |
| Upper Retardation Film | Δn · d | 310 nm |
| 2 | Retardation Axis | 74° |
| Liquid Crystal Layer | Δn · d | 3.72 μm |
| | Twist Angle | 0° |
| Lower Retardation Film | Δn · d | 140 nm |
| 1 | Retardation Axis | 75° |
| Lower Retardation Film | θ | 270 nm |
| 2 | Retardation Axis | 15° |
| Lower Polarizer | Transmission Axis | 0° |

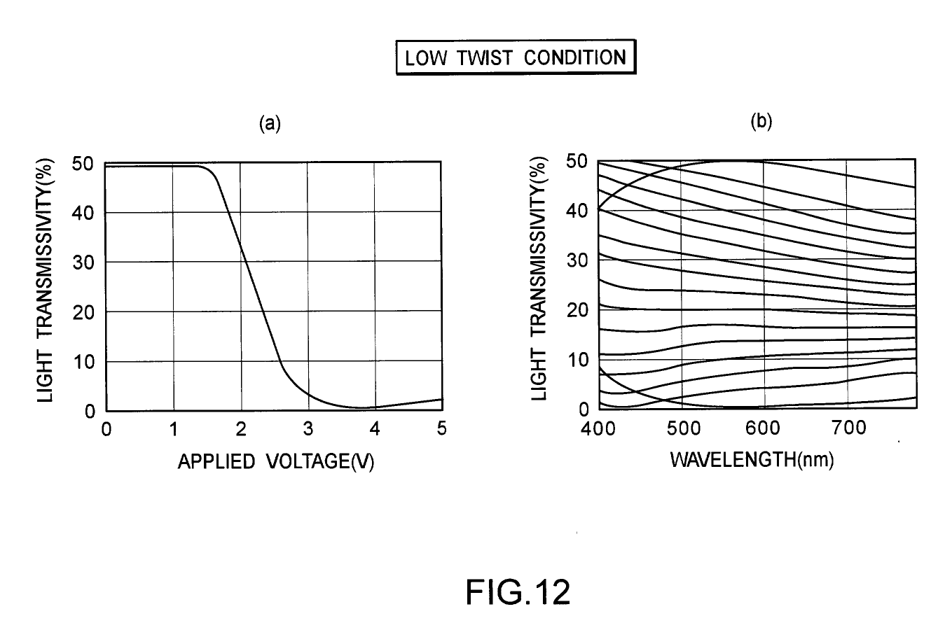

FIG. 12(a) is a graph that shows an example of the relationship (TV characteristics) between applied voltages (V) and light transmissivity (T) of the obtained liquid crystal device in the transmissive display mode. FIG. 12(b) is a graph that shows an example of the spectral characteristics of the light emergent from the liquid crystal device that are observed when voltages of 1.4 V to 3.6 V are applied so as to divide the transmissivity into 15 equal portions in the transmissive display mode. In FIG. 12(b), the upper side in the chart indicates the side closer to white display, while the lower side therein indicates the side closer to black display. Furthermore, in FIG. 12(b), the curve showing the spectral characteristics being flatter means better spectral characteristics with less color dispersion.

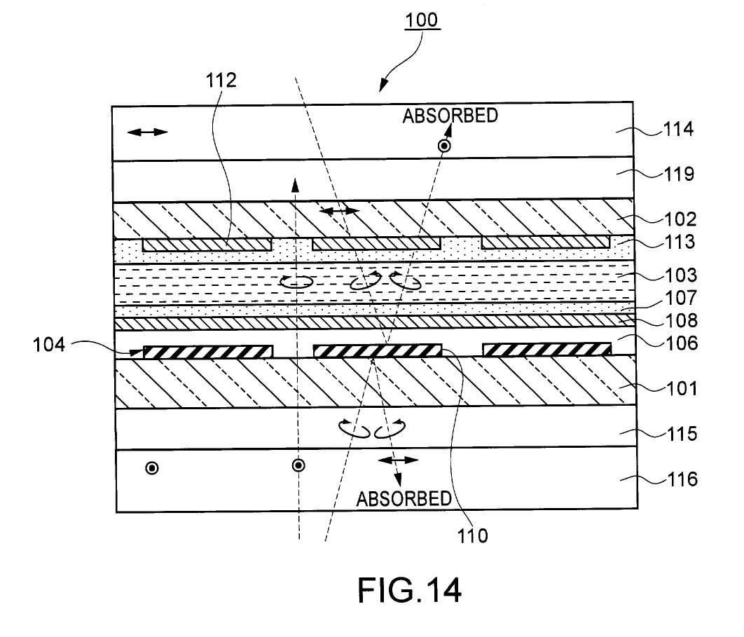

As shown in FIG. 12(a), the liquid crystal device fabricated in this example provides the white display in the non-selection voltage application mode, while it provides the black display in the selection voltage application mode, the light transmissivity when the applied voltage is 0 V is nearly 50%. The remaining 50% light is used for reflective display. In other words, it has been found that in the transmissive display mode, almost all available light can be emitted toward an observer, allowing bright display to be obtained. It has been further discovered that, in the transmissive display mode, 1.7- to 2-fold brightness, as compared with that of the related art transflective liquid crystal device shown in FIG. 14, can be achieved.

Thus, the high light transmissivity can be realized in the white display mode, and the light transmissivity in the black display mode is substantially 0%. Therefore, it has also been found that the present invention enables higher contrast to be achieved.

As illustrated in FIG. 12(b), it has been discovered that, in the transmissive display mode, the curve showing the spectral characteristics as nearly flat means that there is less color dispersion, allowing good display to be obtained.

Although the display characteristics in the reflective display mode have not been illustrated, they showed display substantially as good as those illustrated in FIGS. 12(a) and (b).

### Example 4

As in the case of Example 3, a transflective liquid crystal device in accordance with the present invention was fabricated and the display characteristics of the obtained liquid crystal device were evaluated. Also in this example, two retardation films for each of the upper retardation film and the lower retardation film were disposed to constitute the liquid crystal device under the conditions shown in Table 2. A monochrome display liquid crystal device was fabricated without providing the pigment dispersion type color filter. As shown in Table 2, in this example, the liquid crystal device was constructed with an enhanced or optimum liquid crystal mode under the high twist condition, the twist angle of the liquid crystal layer being 170°.

TABLE 2

| | | |
|---|---|---|
| Upper Polarizer | Transmission Axis | 40° |
| Upper Retardation Film | Δn · d | 580 nm |
| 1 | Retardation Axis | 100° |
| Upper Retardation Film | Δn · d | 40 nm |
| 2 | Retardation Axis | 52° |
| Liquid Crystal Layer | Δn · d | 9.2 μm |
| | Twist Angle | 170° |
| Lower Retardation Film | Δn · d | 140 nm |
| 1 | Retardation Axis | 75° |
| Lower Retardation Film | Δn · d | 270 nm |
| 2 | Retardation Axis | 15° |
| Lower Polarizer | Transmission Axis | 0° |

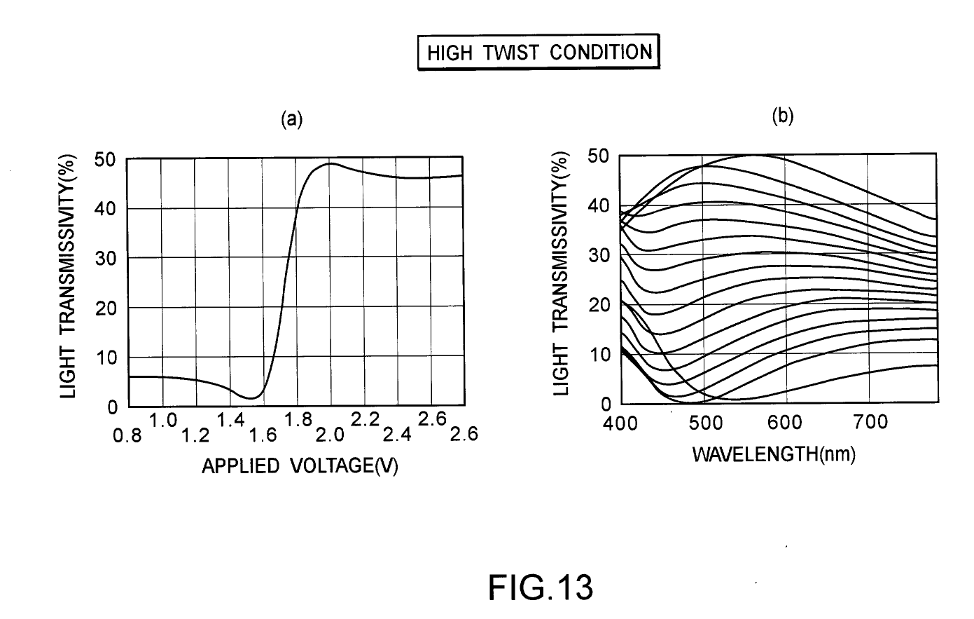

Regarding the obtained liquid crystal device, an example of the TV characteristics in the transmissive display mode and an example of the spectral characteristics of the light emergent from a liquid crystal cell in the transmissive display mode are shown in FIGS. 13(a) and (b), respectively.

As shown in FIG. 13(a), the liquid crystal device fabricated in this example provides the black display in the non-selection voltage application mode, while it provides the white display in the selection voltage application mode. The light transmissivity in the white display mode of the liquid crystal device fabricated in this example is slightly lower than that in the white display mode of Example 3, but it is close to 50%. In other words, it has been found that, also in this example, almost all available light can be emitted toward an observer in transmissive display mode, as in the case of Example 3, allowing bright display to be obtained.

It has been discovered that the light transmissivity in the black display mode of the liquid crystal device fabricated in this example is slightly higher than that in the black display mode of Example 3, but it takes a value close to 0%, thus enabling higher contrast to be achieved also in this example.

As illustrated in FIG. 13(b), it has been discovered that, in the transmissive display mode, the flatness of the curve showing the spectral characteristics is lower than that in Example 3. However, it has been found that there is less color dispersion, allowing good display to be obtained.

### ADVANTAGES

As described in detail above, according to the present invention, it is possible to provide a transflective liquid crystal device that is capable of enhancing the brightness of display in the transmissive mode while maintaining the brightness of display in the reflective mode, and that exhibits superior display characteristics, such as brightness and contrast, in both reflective mode and transmissive mode. Moreover, a transflective liquid crystal device exhibiting superior display characteristics, such as brightness and contrast, can be provided. In addition, electronic equipment with superior display quality can be provided by furnishing it with the liquid crystal device in accordance with the present invention.

What is claimed is:

1. A liquid crystal device, comprising:
a liquid crystal cell in which a liquid crystal layer is sandwiched between an upper substrate and a lower substrate disposed so as to oppose each other;
a voltage applying device to apply a voltage to the liquid crystal layer;
a cholesteric reflective layer that is provided on an inner surface side of the lower substrate and reflects at least a part of circular polarized light having a predetermined direction of rotation; and
an upper substrate elliptic polarized light introducing device to cause elliptic polarized light to be incident upon the liquid crystal layer from the upper substrate side;
the liquid crystal layer having a twist angle ranging from 0 to 12° and a Δn·d value of 0.37±0.05 μm, and the liquid crystal layer inverting the direction of rotation of the incident elliptic polarized light in a non-selection voltage application mode, while not changing the direction of rotation of the incident elliptic polarized light in a selection voltage application mode.

2. A liquid crystal device, comprising:
a liquid crystal cell in which a liquid crystal layer is sandwiched between an upper substrate and a lower substrate disposed so as to oppose each other;
a voltage applying device to apply a voltage to the liquid crystal layer;
a cholesteric reflective layer that is provided on an inner surface side of the lower substrate and reflects at least a part of circular polarized light having a predetermined direction of rotation; and
an upper substrate elliptic polarized light introducing device to cause elliptic polarized light to be incident upon the liquid crystal layer from the upper substrate side;
the liquid crystal layer having a twist angle of 130±20° and a Δn·d value of 0.76±0.05 μm, and the liquid crystal layer inverting the direction of rotation of the incident elliptic polarized light in a non-selection voltage application mode, while not changing the direction of rotation of the incident elliptic polarized light in a selection voltage application.

3. The liquid crystal device according to claim 1, the upper substrate elliptic polarized light introducing device causing an elliptic polarized light having a different direction of rotation from the circular polarized light reflected by the cholesteric reflective layer to be incident upon the liquid crystal layer.

4. A liquid crystal device, comprising:
a liquid crystal cell in which a liquid crystal layer is sandwiched between an upper substrate and a lower substrate disposed so as to oppose each other;
a voltage applying device to apply a voltage to the liquid crystal layer;
a cholesteric reflective layer, that is provided on an inner surface side of the lower substrate and reflects at least a part of circular polarized light having a predetermined direction of rotation; and
an upper substrate elliptic polarized light introducing device to cause elliptic polarized light to be incident upon the liquid crystal layer from the upper substrate side;
the liquid crystal layer having a twist angle ranging from 150° to 270° and a Δn·d value is represented by the following expression (1) when the twist angle is denoted by θ (°), and the liquid crystal layer inverting the direction of rotation of the incident elliptic polarized light in one of a non-selection voltage application mode and a selection voltage application mode, while not changing the direction of rotation of the incident elliptic polarized light in the other mode:
Δn·d value (μm)=−6.7×10⁻⁶×θ²+4.3×10⁻³×θ+0.39±0.1 (1)

5. The liquid crystal device according to claim 4, the upper substrate elliptic polarized light introducing device causing an elliptic polarized light having the same direction of rotation as that of the circular polarized light reflected by the cholesteric reflective layer to be incident upon the liquid crystal layer.

6. The liquid crystal device according to claim 1,
the cholesteric reflective layer functioning as a transflective layer that reflects a part of and transmits a part of the circular polarized light having a predetermined direction of rotation, and
further comprising an illuminating device to cause light to be incident upon the liquid crystal cell from the lower substrate side, and a lower substrate elliptic polarized light introducing device to cause elliptic polarized light to be incident upon the liquid crystal layer from the lower substrate side.

7. The liquid crystal device according to claim 6, the upper substrate elliptic polarized light introducing device and the lower substrate elliptic polarized light introducing device having a polarizer that transmits linear polarized light having a polarization axis in a particular direction and a retardation film to convert the linear polarized light that has been transmitted through the polarizer into elliptic polarized light.

8. Electronic equipment, comprising:
the liquid crystal device according to claim 1.
